(19) United States
(12) Patent Application Publication
(10) Pub. No.: US 2007/0159492 A1
(43) Pub. Date: Jul. 12, 2007

(54) Image processing method and pixel arrangement used in the same

(75) Inventors: Shin-Tai Lo, Miao Li City (TW); Ruey-Shing Weng, Kao Hsiung City (TW); Yi-Fan Chen, Tainan City (TW); Fa-Chen Wu, Sze Hu Hsiang (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/329,067

(22) Filed: Jan. 11, 2006

(51) Int. Cl. G09G 5/02

(52) U.S. Cl. 345/589

(57) ABSTRACT

An image processing method is provided for generating multi-color data comprised of three primary-color sub-pixels and a brightness-enhancing sub-pixel, where a combination selected three at a time from these sub-pixels constituting a target pixel for the image processing method. First, a three-color pixel is converted into a four-color pixel, where the sub-pixels of the four-color pixel identical with those of the target pixel are represented by first numerical values, and the sub-pixel of the four-color pixel different to that of the target pixel is represented by a second numerical value. Then, the first numerical values are correlated with third numerical values discarded by neighboring pixels of the target pixel to determine the actual output of the target pixel.

### BACKGROUND OF THE INVENTION

(a) Field of the Invention

The invention relates to an image processing method and a pixel arrangement used in the image processing method, and particularly to an image processing method and a pixel arrangement for a four-color liquid crystal display.

(b) Description of the Related Art

In an effort to increase the luminance or optical efficiency of an liquid crystal display, the RGBW technology where white sub-pixels are added to an arrangement of red, green, and blue (RGB) sub-pixels has been developed to enhance the overall performance of an LCD TV or a handheld display.

FIG. 1 shows a schematic diagram illustrating a traditional arrangement of RGB sub-pixels. FIGS. 2A and 2B show schematic diagrams respectively illustrating two arrangements of RGBW sub-pixels proposed by Samsung Electronics Corporation.

Referring to FIG. 2A, the red, green, blue and white sub-pixels are arranged in a stripe pattern. Compared to the traditional RGB pixel arrangement shown in FIG. 1, when a white sub-pixel is added in the original pixel area, the area of each of the sub-pixels is reduced by one-fourth to result in a reduced aperture ratio. Further, because the added white sub-pixels require additional data lines prepared for them, the number of driver ICs for the data lines goes up by one-third compared to that of the traditional RGB pixel arrangement to result in an increase in the manufacturing cost.

Next, referring to FIG. 2B, the red, green, blue and white sub-pixels are arranged in a checkerboard pattern. Compared to the traditional RGB pixel arrangement shown in FIG. 1, when a white sub-pixel is added in the original pixel area, the area of each of the sub-pixels is still reduced by one-fourth to result in a reduced aperture ratio. Further, though the number of driver ICs for the data lines is reduced by one-third (each pixel has only two vertical columns of sub-pixels), the number of driver ICs for the scan lines is doubled (each pixel has two horizontal rows of sub-pixels) to result in an increase in the manufacturing cost.

Hence, another RGBW pixel arrangement shown in FIG. 3B is proposed to avoid the shrink of each sub-pixel area. According to this design, white sub-pixels are joined in the traditional RGB pixel arrangement without disturbing its original spread. In other words, the area of each of the red, green, and blue sub-pixels does not alter as the white sub-pixels are included therein. Also, the area of the white sub-pixel may be the same as the red, green, or blue sub-pixel.

However, comparing FIG. 3B with FIG. 3A, thought, in the RGBW pixel arrangement, the red, green, and blue sub-pixels may maintain their original areas, its screen resolution is considerably reduced. Specifically, in a RGB color system, a dot serving as the estimate basis of the screen resolution consists of three sub-pixels, while a dot serving as the estimate basis of the screen resolution consists of four sub-pixels in a RGBW color system. Hence, since the horizontal span PX′ of a dot in the RGBW color system is expanded to one-third more than the horizontal span PX of a dot in the RGB color system, the horizontal resolution in the RGBW color system is reduced by one-fourth compared to that in the RGB color system under the same screen area. For example, if the screen resolution of a RGB color display is 176*RGB*220, the screen resolution of a RGBW color display is reduced to 132*RGBW*220 (176*¾=132).

### BRIEF SUMMARY OF THE INVENTION

Hence, an object of the invention is to provide a pixel arrangement and an image processing method for a four-color liquid crystal display capable of maintaining the same aperture ratio and screen resolution as that in a three-color liquid crystal display.

According to the invention, the image processing method is used for generating multi-color data comprised of three primary-color sub-pixels and a brightness-enhancing sub-pixel, where a combination selected three at a time from these sub-pixels constituting a target pixel for the image processing method. First, a three-color pixel is converted into a four-color pixel by extracting a white component from the three-color pixel, where the sub-pixels of the four-color pixel identical with those of the target pixel are represented by first numerical values, and the sub-pixel of the four-color pixel different to that of the target pixel is represented by a second numerical value. Then, the target pixel is provided with the first numerical values and with third numerical values discarded by neighboring pixels of the target pixel, and the first numerical values are correlated with the third numerical values to determine the actual output numerical values of the target pixel. The numerical values may be grayscale values of sub-pixels.

Also, the colors of the primary-color sub-pixels may be additive primaries such as red, green, and blue, or subtractive primaries such as cyan, magenta, and yellow. The color of the brightness-enhancing sub-pixel may be a mix of at least two of red, green, and blue primary colors.

Further, the invention also provides a pixel arrangement used in the image processing method for a four-color liquid crystal display. The pixel arrangement includes multiple rows of sub-pixels each comprised of a sequence of three primary-color sub-pixels and a brightness-enhancing sub-pixel, wherein each two adjacent sub-pixels in one row are distinct from each other, and two identical sub-pixels that are respectively arranged in two immediately adjacent rows are staggered in relation to each other with two sub-pixel positions.

Through the design of the invention, since the color compensation treatment is preformed at the same time when three-color pixels are converted into four-color pixels, the particularly defined pixel of the invention that consists of three sub-pixels is qualified as an effective pixel for the evaluation of RGBW display resolution. Hence, the areas of the original red, green, and blue sub-pixels do not alter as the brightness-enhancing white sub-pixel is added to form a RGBW color display, and the horizontal resolution of the RGBW color display may maintain the same level compared to that in a RGB color display. In other words, the subject invention may satisfy both demands of high resolution and enhanced brightness.

### BRIEF DESCRIPTION OF THE DRAWINGS

FIG. 1 shows a schematic diagram illustrating a traditional arrangement of RGB sub-pixels.

FIGS. 2A and 2B show schematic diagrams illustrating two arrangements of RGBW sub-pixels proposed by Samsung Electronics Corporation.

FIG. 3A shows a schematic diagram illustrating a traditional arrangement of RGB sub-pixels.

FIG. 3B shows a schematic diagram illustrating another arrangement of RGBW sub-pixels.

FIG. 4A to FIG. 4D are schematic diagrams illustrating a pixel arrangement of red, green, blue and white sub-pixels in a RGBW color system according to the invention.

FIGS. 5A, 5B, 6A and 6B are schematic diagrams illustrating an image processing method of the invention in cooperation with the pixel arrangement shown in FIG. 4A to FIG. 4D.

FIG. 7 shows a flowchart of an image processing method according to the invention.

FIG. 8 shows a schematic diagram illustrating an exemplified four-color converting device for extracting a white component from a three-color pixel.

FIG. 9 shows a schematic diagram illustrating another pixel arrangement of the invention.

FIG. 10 shows a schematic diagram illustrating another pixel arrangement of the invention.

FIG. 11 shows a schematic diagram illustrating the image processing method of the invention implemented on a traditional pixel arrangement shown in FIG. 2A.

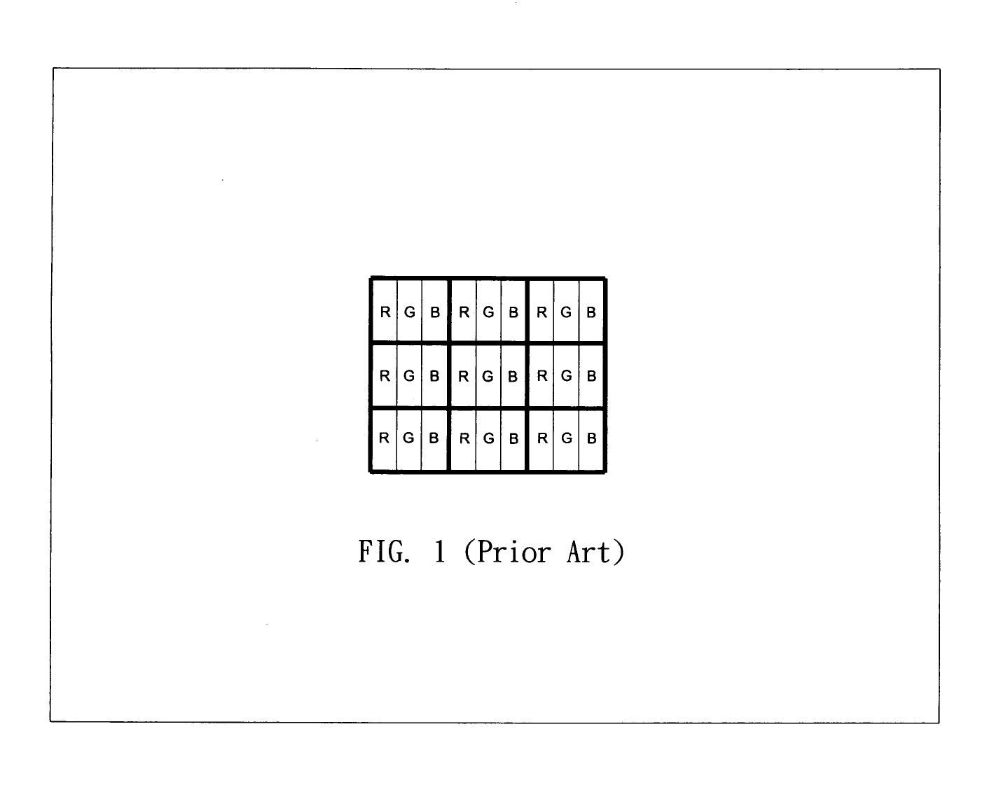

### DETAILED DESCRIPTION OF THE INVENTION

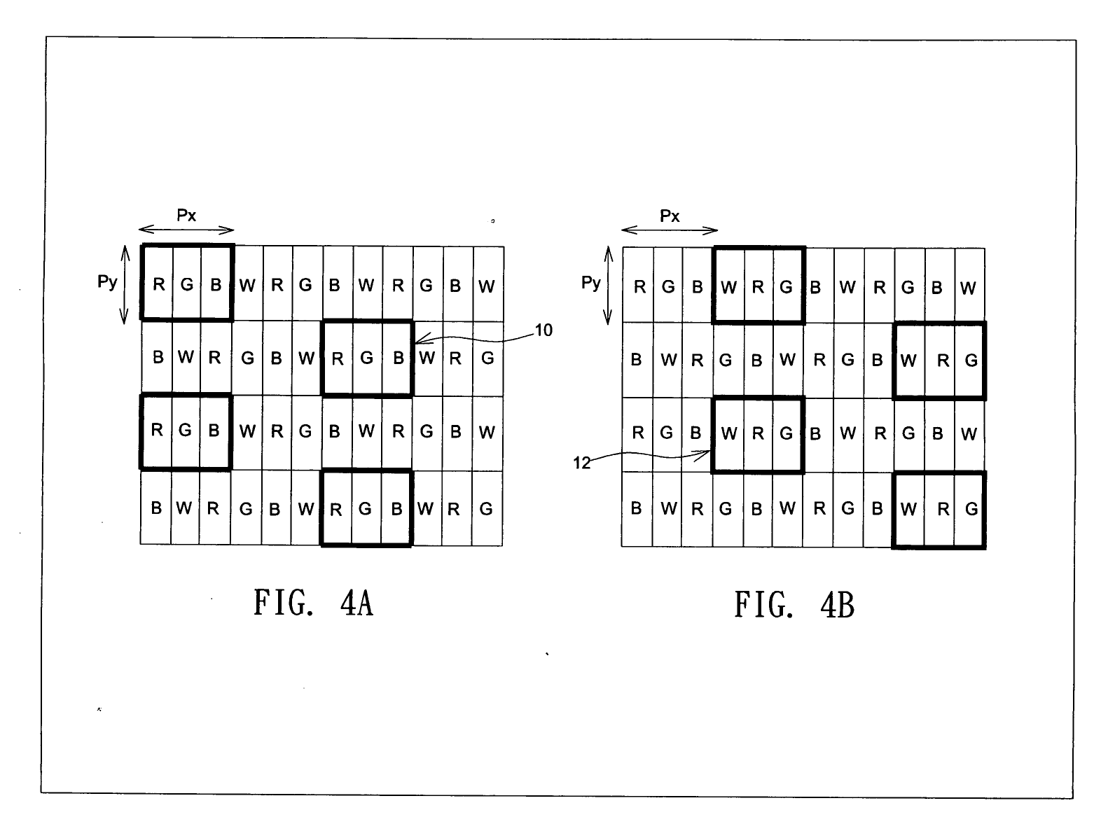

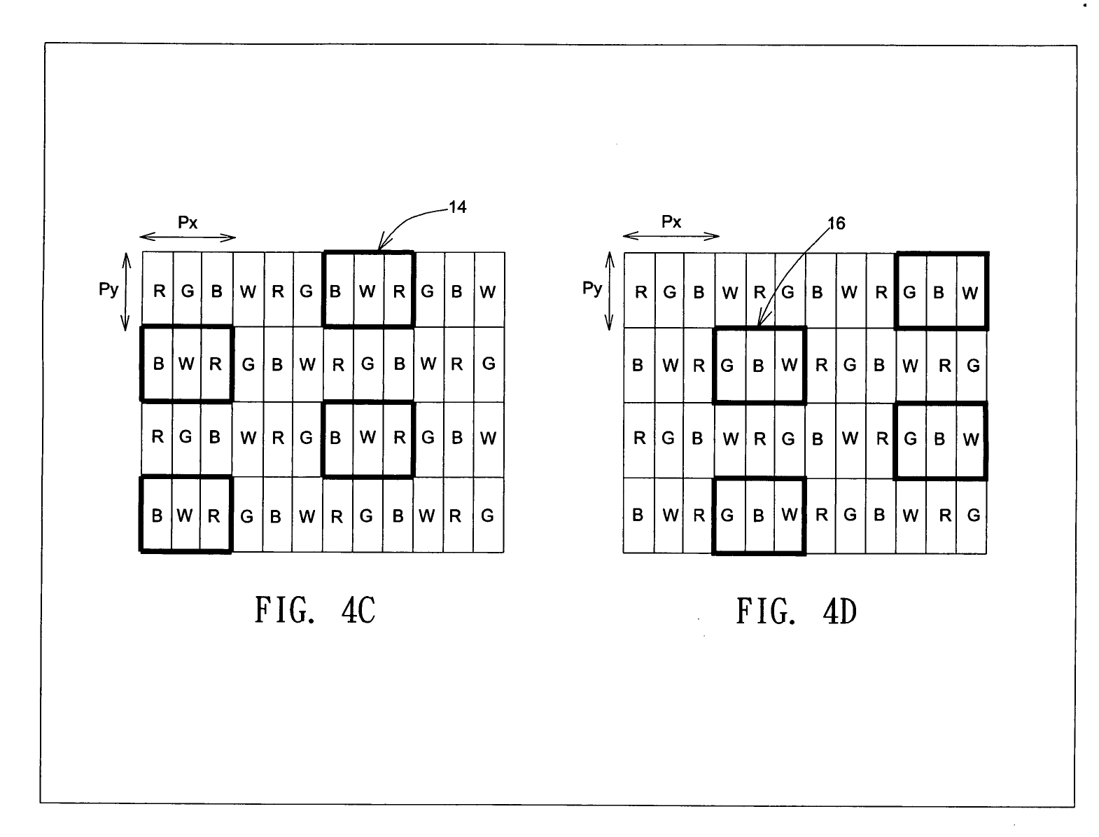

FIG. 4A to FIG. 4D are schematic diagrams illustrating a pixel arrangement of red, green, blue and white sub-pixels in a RGBW color system according to the invention. These diagrams also indicate four types of particularly defined pixels serving as a basis on which a later described image processing method of the invention is based.

The RGBW pixel arrangement according to the invention includes multiple rows of sub-pixels, with each row being a sequence of red, green, blue and white sub-pixels, and they are arranged in a specific order as described below.

1. Each two adjacent sub-pixels in one row are distinct from each other. In other words, the red, green, blue and white sub-pixels are arranged in turn without continuous repeat.

2. Two identical sub-pixels that are respectively arranged in two immediately adjacent rows are staggered in relation to each other with two sub-pixel positions. Taking FIG. 4A as an example, as a red sub-pixel appears at the first position counting from the left in the top first row, another red sub-pixel nearest to it in the top second row appears at the third position counting from the left.

Next, according to the invention, in order to keep the horizontal resolution of the RGBW color system identical with that of a RGB color system, a pixel in the RGBW color system is particularly defined as consisting of three sub-pixels to cooperate with the image processing method of the invention. Hence, there are four combinations of the red, green, blue and white sub-pixels selected three at a time, and they are listed as the following:
Type 1: RGB (pixel 10 as indicated in bold line shown in FIG. 4A)
Type 2: WRG (pixel 12 as indicated in bold line shown in FIG. 4B)
Type 3: BWR (pixel 14 as indicated in bold line shown in FIG. 4C)
Type 4: GBW (pixel 16 as indicated in bold line shown in FIG. 4D)

Though each type of the pixels lacks one sub-pixel compared to the four red, green, blue and white sub-pixels, the absent sub-pixel may appear in immediately adjacent areas of all its neighboring pixels, so that fine color compensation performed by the later described image processing method is achieved to provide the same display effect as in a common RGB color display. Taking the pixel 10 shown in FIG. 4A as an example, the white sub-pixel absent from the pixel 10 appears in the top and bottom of the green sub-pixel, left of the red sub-pixel, and right of the blue sub-pixel. In other words, the white sub-pixel may appear in immediately adjacent areas of all neighboring pixels 12, 14 and 16 of the pixel 10 to achieve best color compensation. Similarly, the sub-pixel absent from each of the pixels 12, 14, and 16 compared to the four red, green, blue and white sub-pixels is arranged in the same manner.

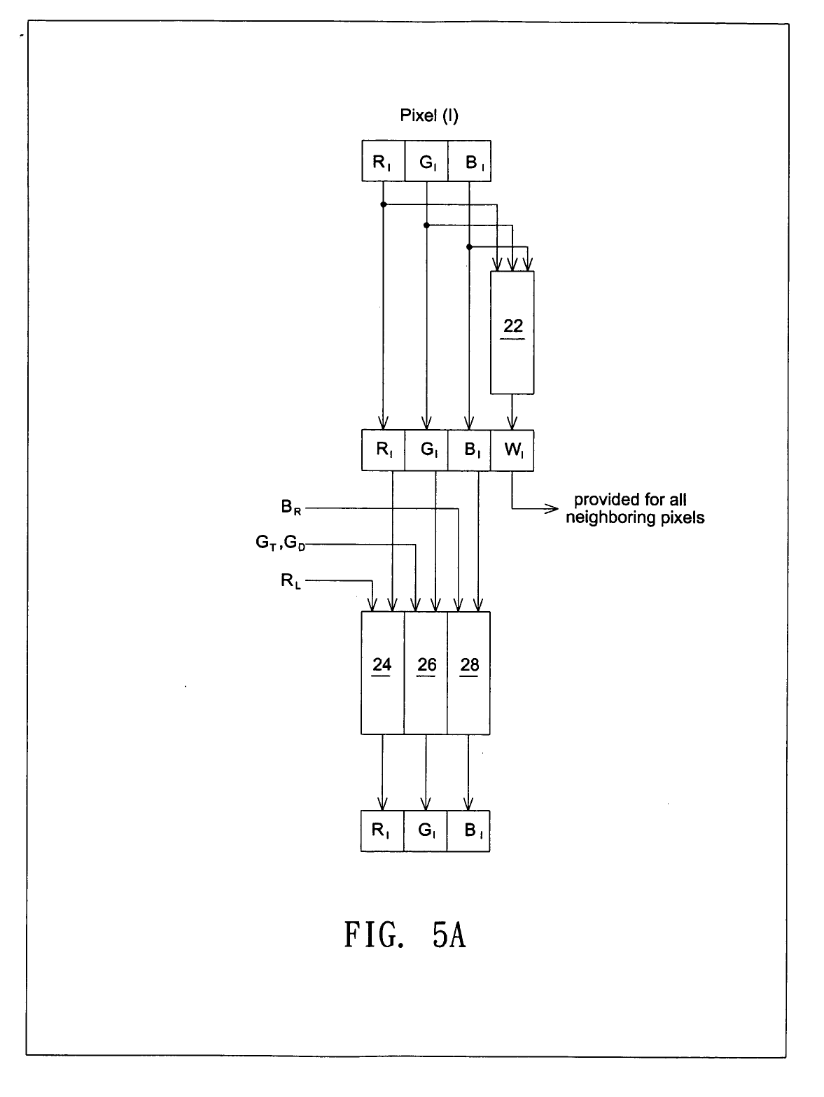

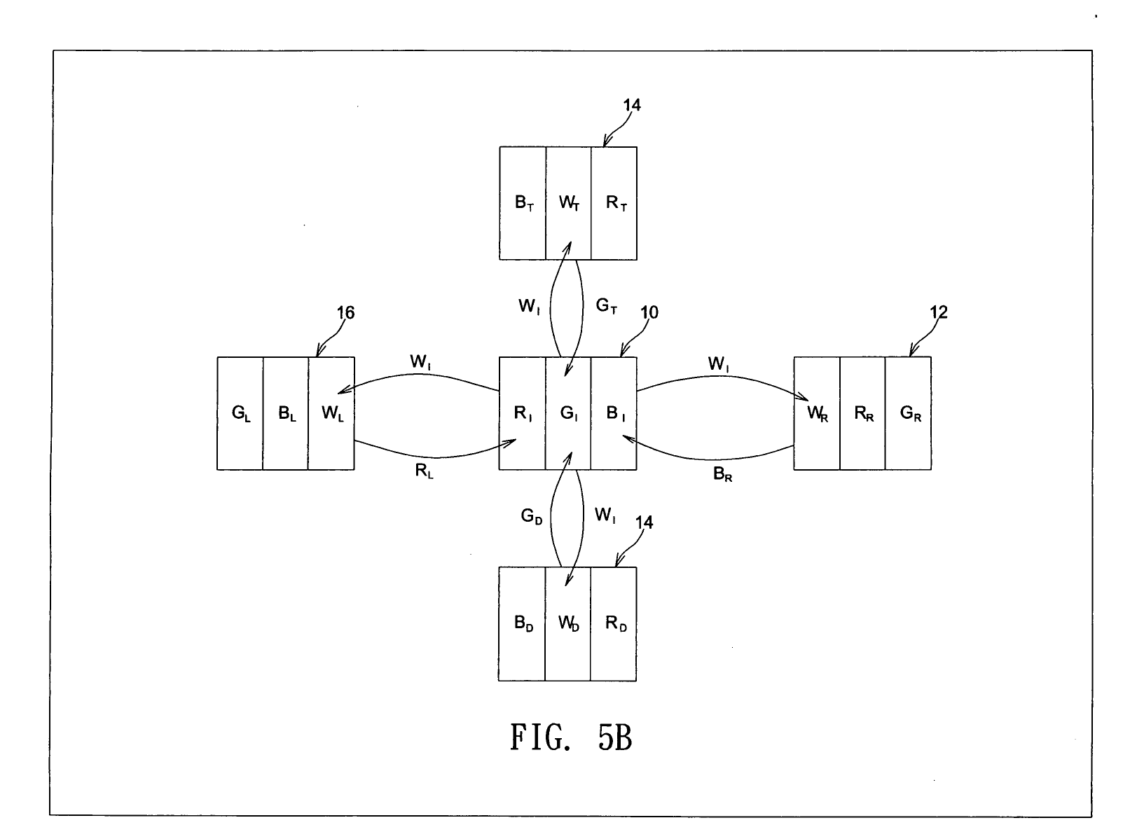

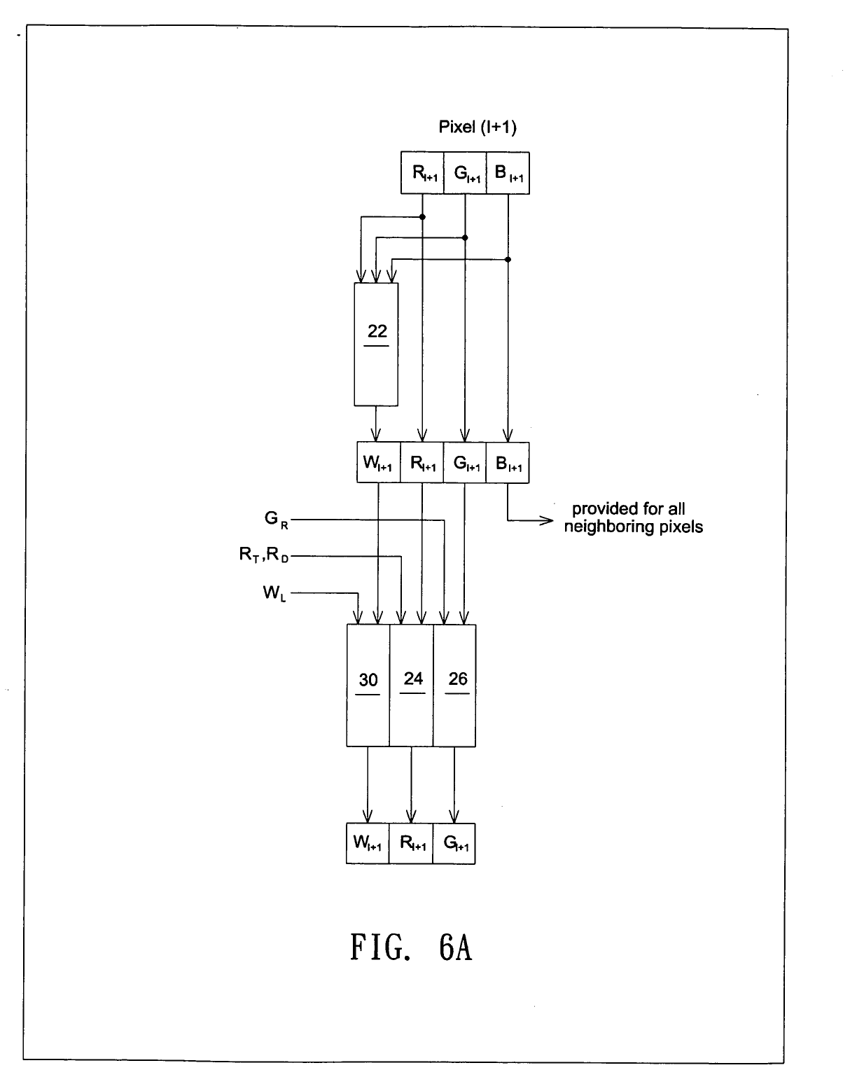

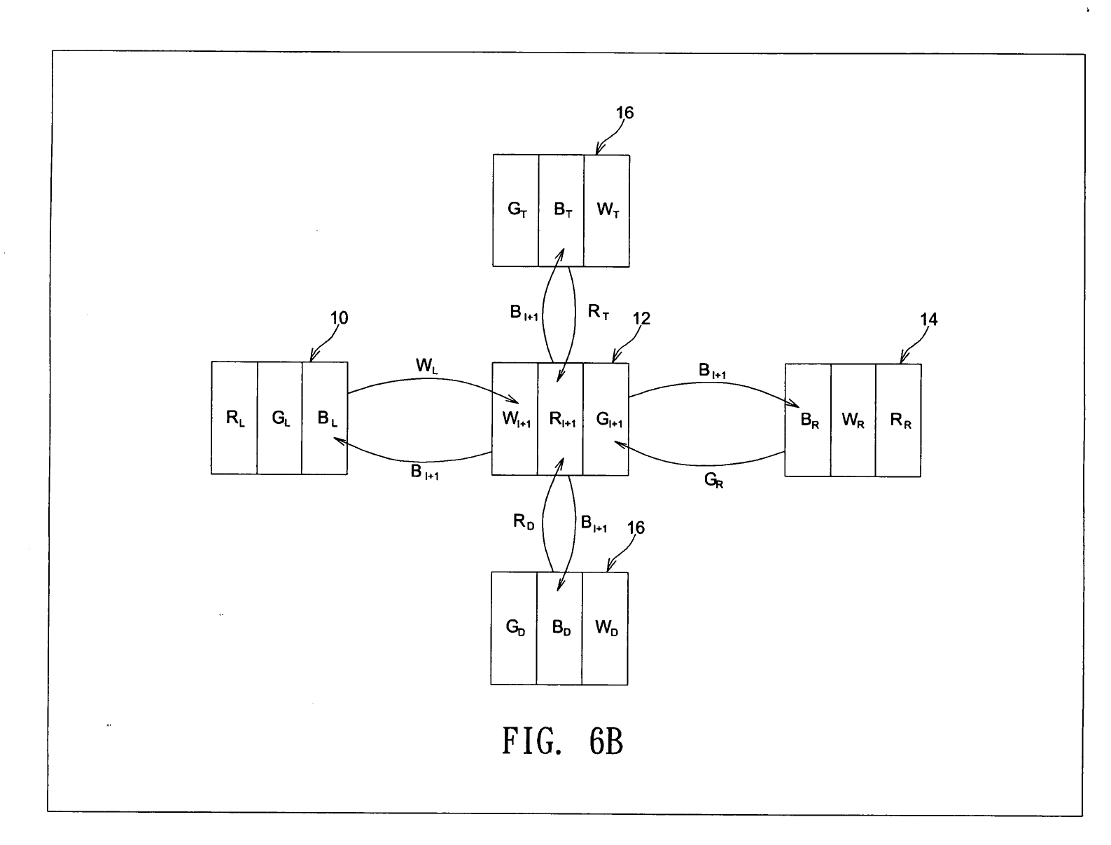

FIGS. 5A, 5B, 6A and 6B are schematic diagrams illustrating an image processing method of the invention in cooperation with the pixel arrangement shown in FIG. 4A to FIG. 4D.

According to the image processing method of the invention, the color compensation is designed to accompany the conversion of a three-color pixel to a four-color pixel. First, Pixel (I) in a RGB format including sub-pixels R_{I}, G_{I}, and B_{I}, is selected as an initial unit to be processed, as shown in FIG. 5A. Then, the grayscale values of the sub-pixels R_{I}, G_{I}, and B_{I}, are inputted in a four-color converting device 22 for converting them into grayscale values of sub-pixels R_{I}, G_{I}, B_{I}, and W_{I} in a RGBW format, where any method known in the art for extracting a white component from the Pixel (I) is used in this conversion.

FIG. 5B shows a schematic diagram illustrating an exemplified treatment of the color compensation, where the pixel 10 in the RGBW format (including red, green, and blue sub-pixels, as shown in FIG. 4A) is selected as a target pixel for the treatment and receives the converted grayscale values of the sub-pixels R_{I}, G_{I}, and B_{I}, from the Pixel (I).

Referring to FIG. 5B, though pixel 10 lacks white sub-pixel compared to the four sub-pixels of a four-color pixel, the absent white sub-pixel may appear in its immediately adjacent areas (W_{R}, W_{T}, W_{D}, and W_{L}) of neighboring pixels 12, 14, and 16 for color compensation. Specifically, during the color compensation treatment, after the grayscale values of the sub-pixels R_{I}, G_{I}, and B_{I}, are converted into grayscale values of sub-pixels R_{I}, G_{I}, B_{I}, and W_{I}, the grayscale value of the sub-pixel W_{I} is redundant for the pixel 10 (Type 1 pixel includes only RGB sub-pixels) and thus are discarded by the pixel 10 and then provided for neighboring white sub-pixels, including sub-pixel W_{R} of the pixel 12, sub-pixels W_{T} and W_{D} of the pixel 14, and sub-pixel W_{L} of the pixel 16.

On the other hand, referring to FIG. 6A, Pixel (I+1) in the RGB format including sub-pixels R_{I+1}, G_{I+1}, and B_{I+1} is subsequently selected to proceed with the conversion, and the grayscale values of the sub-pixels R_{I+1}, G_{I+1}, and B_{I+1} are inputted in the four-color converting device 22 for converting them into grayscale values of sub-pixels R_{I+1}, G_{I+1}, B_{I+1}, and W_{I+1} in the RGBW format.

Then, referring back to FIG. 5B, the grayscale values of the sub-pixels W_{I+1}, R_{I+1}, and G_{I+1} from Pixel (I+1) are selected as the grayscale values of sub-pixels W_{R}, R_{R}, and G_{R} of the pixel 12. Since the grayscale value of the sub-pixel B_{R} (namely the grayscale value of sub-pixel B_{I+1}) is redundant for the pixel 12 (Type 2 pixel including only WRG sub-pixels), it is discarded by the pixel 12 and then provided for the neighboring sub-pixel B_{I}, of the pixel 10. Following similar procedures, the grayscale values of sub-pixel G_{T} and sub-pixel G_{D} redundant for the pixel 14 (Type 3 pixel including only BWR sub-pixels) are discarded and then provided for the neighboring sub-pixel G_{I} of the pixel 10, and the grayscale value of sub-pixel R_{L} redundant for the pixel 16 (Type 4 pixel including only GBW sub-pixels) is discarded and then provided for the neighboring sub-pixel R_{I} of the pixel 10.

Finally, referring back to FIG. 5A, the converted grayscale value of sub-pixel R_{I} from the Pixel (I) and the grayscale value of the sub-pixel R_{L} provided from the neighboring pixel 16 are transmitted into a red-color correlator and then correlated according to a specific weight to determine the actual output grayscale value of the red sub-pixel of the pixel 10. Similarly, the converted grayscale value of the sub-pixel G_{I} from the Pixel (I) and the grayscale values of the sub-pixels G_{T} and G_{D} provided from the neighboring pixel 14 are transmitted into a green-color correlator to determine the actual output grayscale value of the green sub-pixel of the pixel 10. Further, the converted grayscale value of the sub-pixel B_{I} from the Pixel (I) and the grayscale value of the sub-pixel B_{R} provided from the neighboring pixel 12 are transmitted into a blue-color correlator to determine the actual output grayscale value of the blue sub-pixel of the pixel 10. The specific weight may be adjusted basing on the visual effect of output images.

In comparison, FIG. 6B shows a schematic diagram illustrating another color compensation treatment that occurs simultaneously with the treatment shown in FIG. 5B, where pixel 12 in the RGBW format (including white, red, and green sub-pixels, as shown in FIG. 4B) is selected as a target pixel for the treatment and receives the converted grayscale values of the sub-pixels W_{I+1}, R_{I+1}, and G_{I+1} from Pixel (I+1).

Referring to FIG. 6B, though pixel 12 lacks blue sub-pixel compared to the four sub-pixels of a four-color pixel, the absent blue sub-pixel may appear in its immediately adjacent areas (B_{L}, B_{T}, B_{D}, and B_{R}) of neighboring pixels 10, 14 and 16 for color compensation. Specifically, during the color compensation treatment, after the grayscale values of the sub-pixels R_{I+1}, G_{I+1}, and B_{I+1} are converted into grayscale values of sub-pixels R_{I+1}, G_{I+1}, B_{I+1}, and W_{I+1}, the grayscale value of the sub-pixel B_{I+1} is redundant for the pixel 12 (Type 2 pixel including only WRG sub-pixels) and thus are discarded by the pixel 12 and then provided for neighboring blue sub-pixels, including sub-pixel B_{L} of the pixel 10, sub-pixel B_{R} of the pixel 14, and sub-pixels B_{T} and B_{D} of the pixel 16.

On the other hand, since the grayscale value of the W_{L} sub-pixel is redundant for the pixel 10, it is discarded by the pixel 10 and then provided for the neighboring sub-pixel W_{I+1} of the pixel 12. Similarly, the grayscale value of sub-pixel G_{R} redundant for the pixel 14 are discarded and then provided for the neighboring sub-pixel G_{I+1} of the pixel 12, and the grayscale values of sub-pixel R_{T} and sub-pixel R_{D} redundant for the pixel 16 are discarded and then provided for the neighboring sub-pixel R_{I+1} of the pixel 12.

Finally, referring back to FIG. 6A, the converted grayscale value of the sub-pixel W_{I+1} from the Pixel (I+1) and the grayscale value of the sub-pixel W_{L} provided from the neighboring pixel 10 are transmitted into a white-color correlator and then correlated according to a specific weight to determine the actual output grayscale value of the white sub-pixel of the pixel 12. Similarly, the converted grayscale value of the sub-pixel R_{I+1} from the Pixel (I+1) and the grayscale values of the sub-pixels R_{T} and R_{D} provided from the neighboring pixel 16 are transmitted into a red-color correlator and then correlated to determine the actual output grayscale value of the red sub-pixel of the pixel 12. Further, the converted grayscale value of the sub-pixel G_{I+1} from the Pixel (I+1) and the grayscale values of the sub-pixel GR provided from the neighboring pixel 14 are transmitted into a green-color correlator to determine the actual output grayscale value of the green sub-pixel of the pixel 12.

Thereafter, another three-color pixels are continually fetched and in turn converted into the four type of the pixels particularly defined by the invention, with the similar color compensation treatment being performed to thus achieve the same display effect as in a common RGB color display.

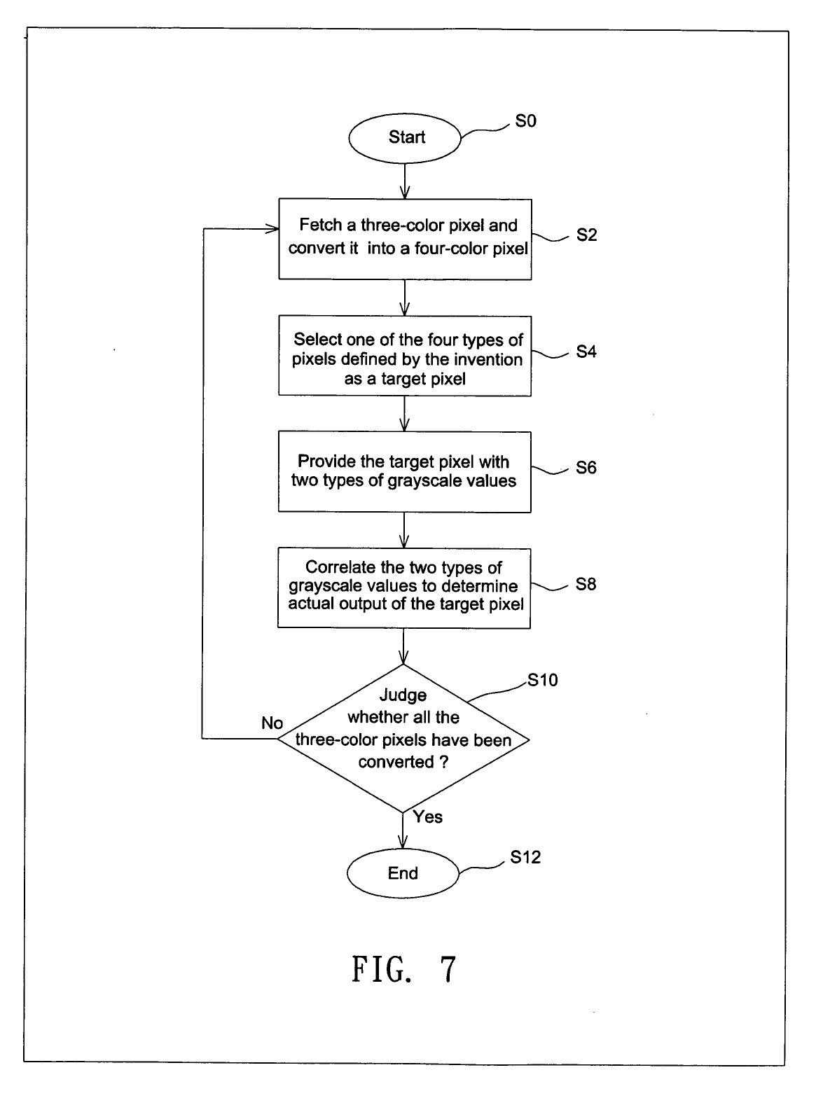

FIG. 7 shows a flowchart of the image processing method according to the invention. The image processing steps are described below.

Step S0: Start.

Step S2: Fetch a three-color pixel of an image in a RGB format, and convert the three-color pixel into a four-color pixel having four grayscale values of red, green, blue, and white sub-pixels by extracting a white component from the three-color pixel.

Step S4: Select one of the four types of pixels (RGB, WRG, BWR, GBW) defined by the invention as a target pixel. Compare the sub-pixels of the target pixel with that of the four-color pixel, where the sub-pixels of the four-color pixel identical with those of the target pixel are represented by first grayscale values, and the sub-pixel of the four-color pixel different to that of the target pixel is represented by a second grayscale value.

Step S6: Provide the target pixel with the first grayscale values and third grayscale values that are discarded by neighboring pixels of the target pixel. Meanwhile, the target pixel discards the second grayscale value of the four-color pixel to all the neighboring pixels.

Step S8: Correlate the first grayscale values with the third grayscale values to determine the actual output grayscale values of the target pixel.

Step S10: Fetch another three-color pixel of the image and take turns to select another type of pixels as a target pixel to repeat step S6 and step S8. Then, judge whether all three-color pixels have been converted into the target pixels defined by the invention. If yes, go to step S12; if no, go back to step S2.

Step S12: End.

Through the design of the invention, since the color compensation treatment is preformed at the same time when the three-color pixels are converted into four-color pixels, the particularly defined pixel of the invention that consists of three sub-pixels is qualified as an effective pixel for the evaluation of RGBW display resolution. Hence, the areas of the original red, green, and blue sub-pixels do not alter as the brightness-enhancing white sub-pixel is added to form a RGBW color display, and the horizontal resolution of the RGBW color display may maintain the same level compared to that in a RGB color display. In other words, the subject invention may satisfy both demands of high resolution and enhanced brightness.

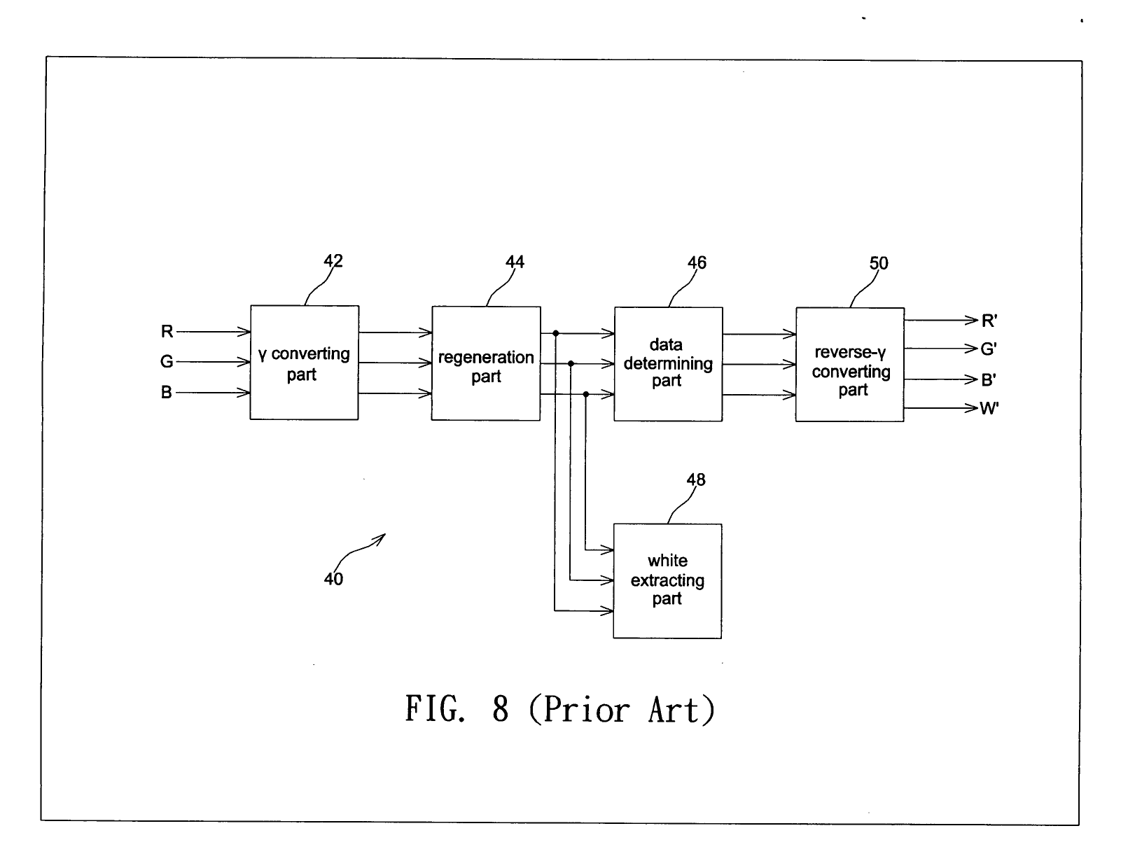

Further, as is well known in the art, the method for extracting a white component from a three-color pixel is not limited according to the invention. An exemplary method is shown in FIG. 8. Referring to FIG. 8, a four-color converting device 40, which includes a gamma converting part 42, a regeneration part 44, a data determining part 46, a white extracting part 48, and a reverse-gamma converting part 50, converts primary RGB grayscale data into four-color RGBW data.

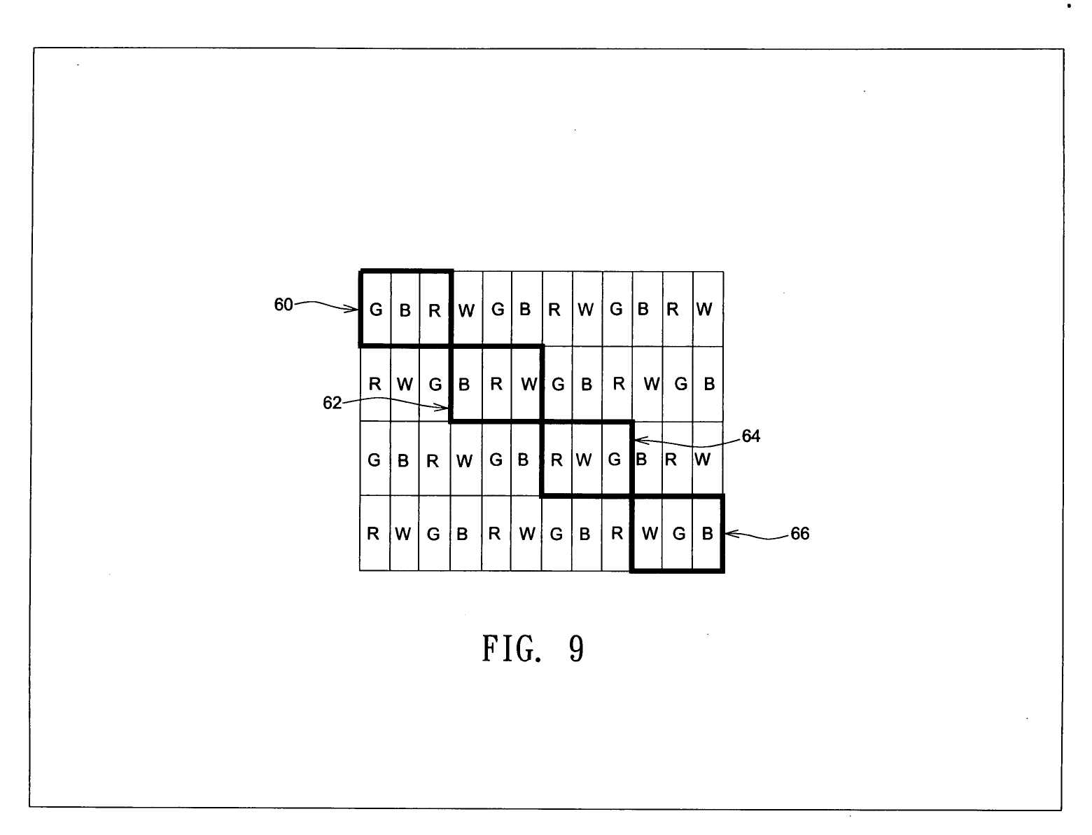

Also, the pixel arrangement of the invention requires only to follow the rule where each two adjacent sub-pixels in one row are distinct, and two identical sub-pixels that are respectively arranged in two immediately adjacent rows are staggered in relation to each other with two sub-pixel positions, and the sequence of sub-pixels in one particularly defined pixel of the invention is not restricted. For example, as shown in FIG. 9, the four types of pixels according to the invention may be selected as pixel 60 (GBR sub-pixels), pixel 62 (BRW sub-pixels), pixel 64 (RWG sub-pixels), and pixel 66 (WGB sub-pixels).

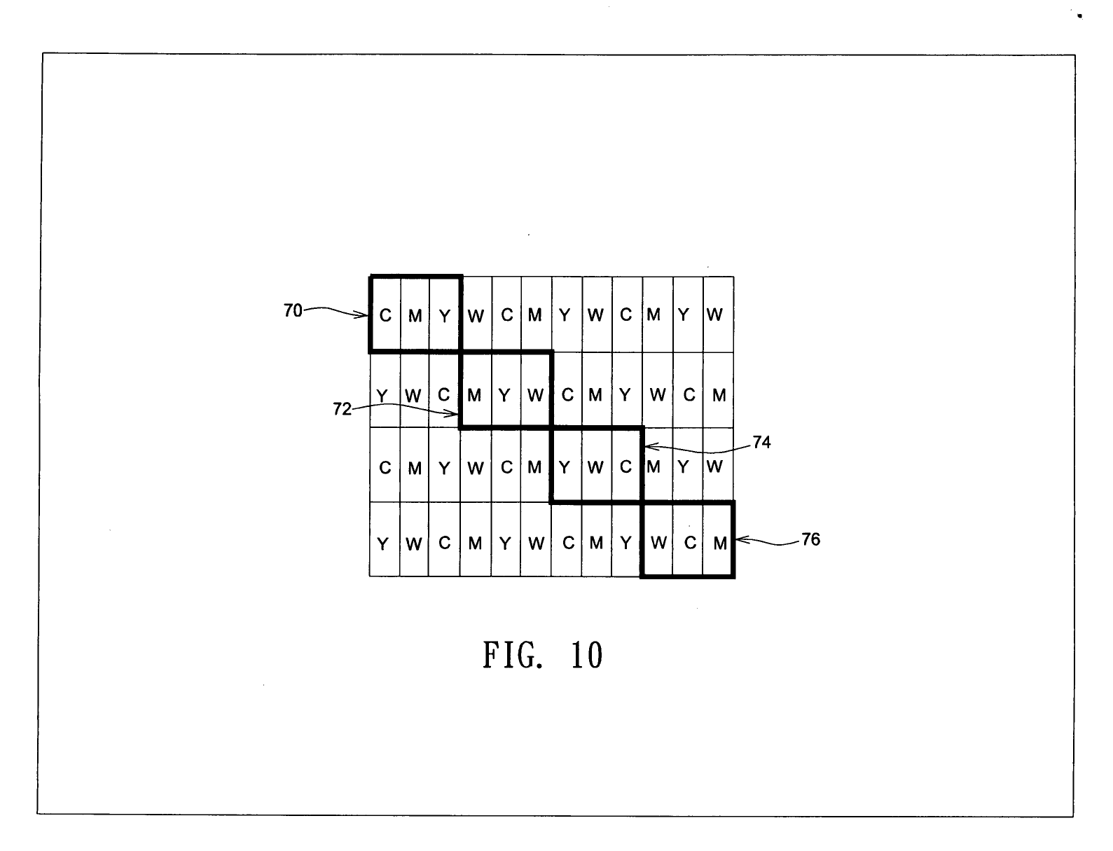

Further, the colors of the sub-pixels of the invention include, but are not limited to, red, green, and blue of additive primaries. Other colors such as cyan (C), magenta (M), and yellow (Y) of subtractive primaries used in a subtractive color model may also be applied. As shown in FIG. 10, a CMYW pixel arrangement including pixel 70 (CMY sub-pixels), pixel 72 (MYW sub-pixels), pixel 74 (YWC sub-pixels), and pixel 76 (WCM sub-pixels) may also be used in the invention. Besides, the W sub-pixel used for enhance the brightness of a display is not limited in a white color. On the contrary, its color may be any mix of at least two of the additive primaries to thus enhance the brightness.

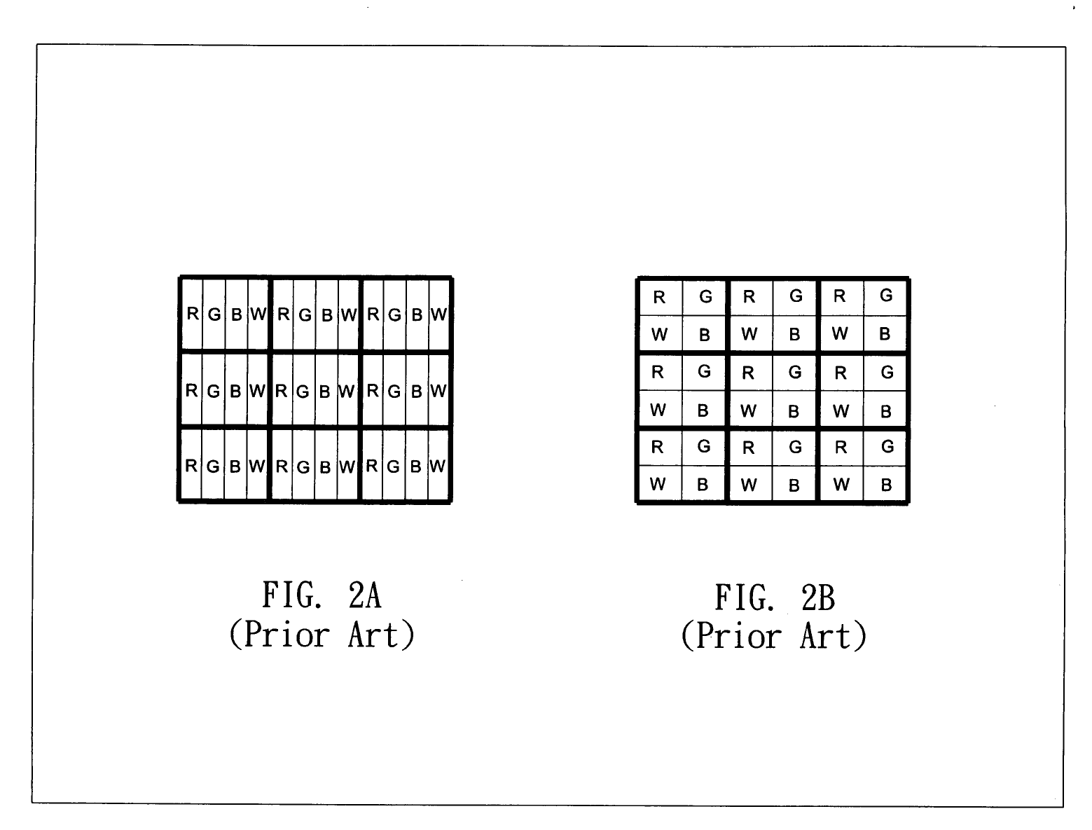

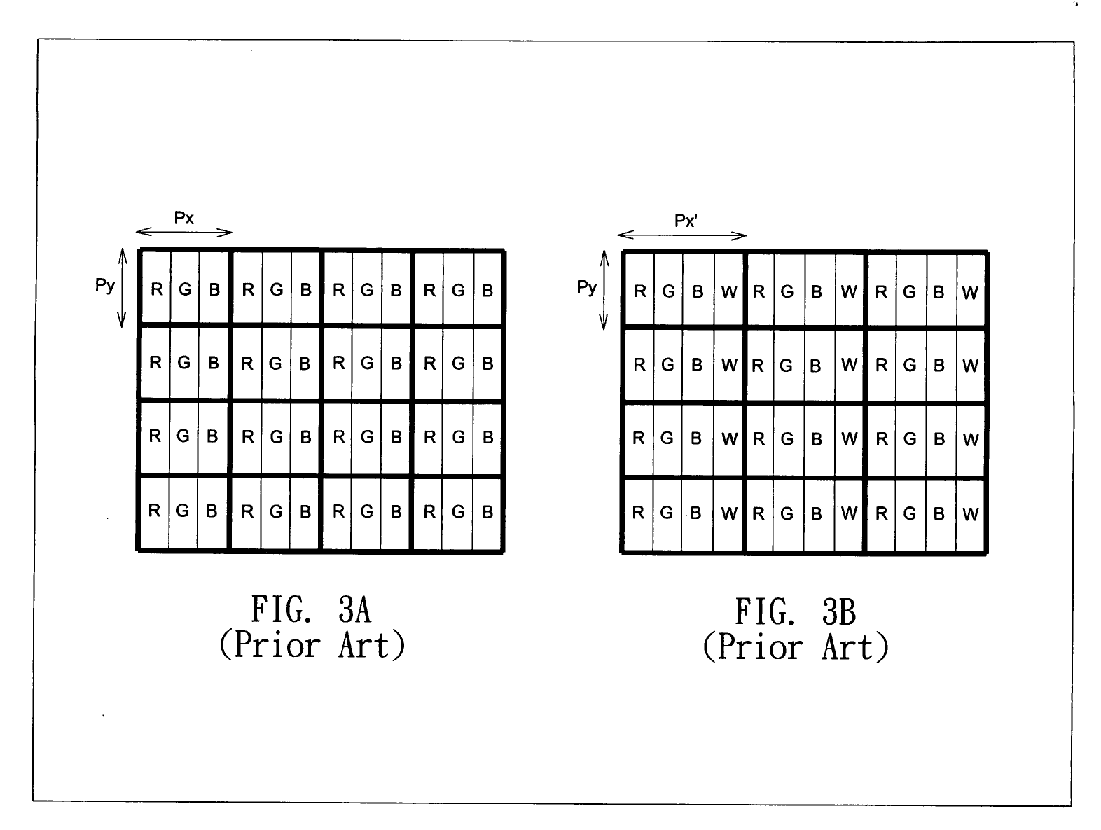

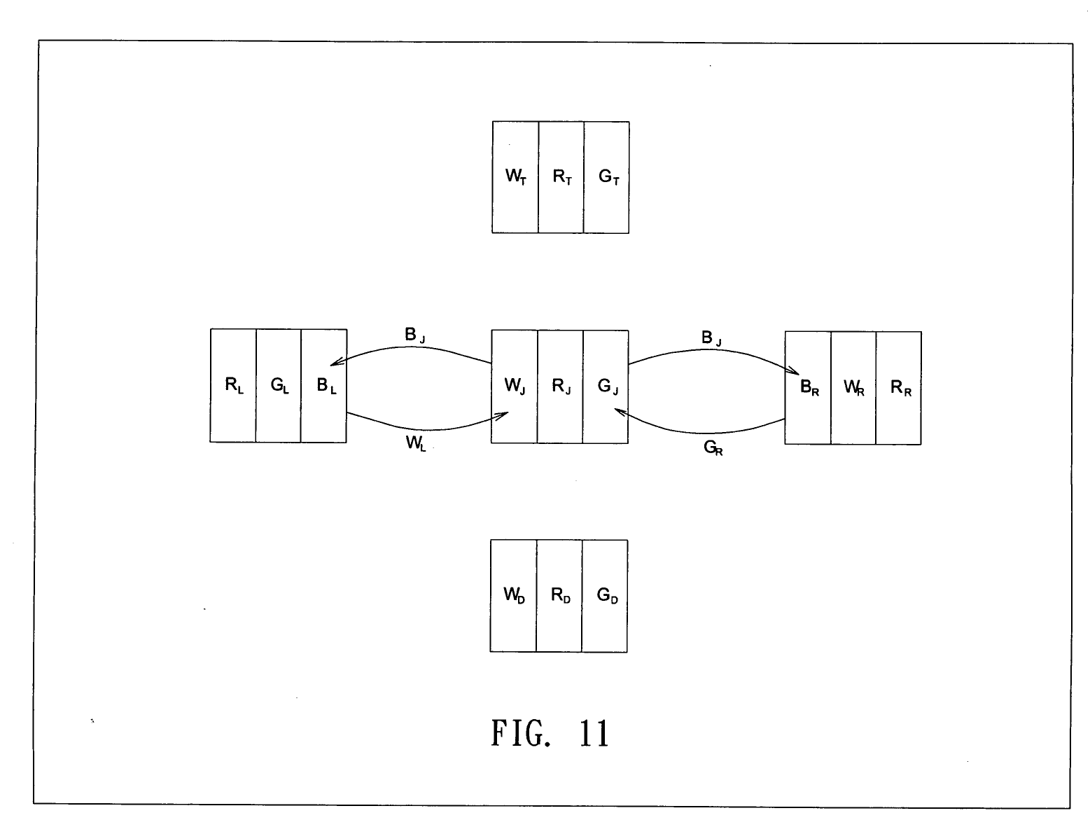

Although the image processing method of the invention may achieve the best color compensation effect when cooperating with the pixel arrangement shown in FIG. 4A-4D, it should be noted that such method may be implemented on other pixel arrangement as circumstances permit. For example, referring to FIG. 11, the image processing method may be implemented on the traditional pixel arrangement shown in FIG. 2A to achieve one dimensional color compensation; that is, the interchange of grayscale-values occurs only between the target pixel and the left and right neighboring pixels.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An image processing method for generating multi-color data comprised of three primary-color sub-pixels and a brightness-enhancing sub-pixel, where a combination selected three at a time from these sub-pixels constituting a target pixel for the image processing method, the method comprising the steps of:
converting a three-color pixel into a four-color pixel by extracting a white component from the three-color pixel, where the sub-pixels of the four-color pixel identical with those of the target pixel are represented by first numerical values, and the sub-pixel of the four-color pixel different to that of the target pixel is represented by a second numerical value;
providing the target pixel with the first numerical values and with third numerical values discarded by neighboring pixels of the target pixel; and
correlating the first numerical values with the third numerical values to determine the actual output numerical values of the target pixel.

2. The image processing method as claimed in claim 1, wherein the second numerical value is provided for each of the neighboring sub-pixels of the target pixel.

3. The image processing method as claimed in claim 1, wherein the sub-pixel not selected in the combination of the target pixel appears in an immediately adjacent area of each of the neighboring pixels of the target pixel.

4. The image processing method as claimed in claim 1, wherein each of the neighboring pixels of the target pixel is a combination selected three at a time from the three primary-color sub-pixels and the brightness-enhancing sub-pixel, and each of the third numerical values includes the numerical value of the sub-pixel not selected in the combination of each of the neighboring pixels.

5. The image processing method as claimed in claim 1, wherein, when the target pixel is comprised of the three primary-color sub-pixels, the first numerical values include numerical values of the three primary-color sub-pixel, and, when the target pixel is comprised of two of the three primary-color sub-pixels and the brightness-enhancing sub-pixel, the first numerical values include numerical values of the two primary-color sub-pixels and the brightness-enhancing sub-pixel.

6. The image processing method as claimed in claim 1, wherein, when the target pixel is comprised of the three primary-color sub-pixels, the third numerical values include numerical values of the three primary-color sub-pixels, and, when the target pixel is comprised of two of the three primary-color sub-pixels and the brightness-enhancing sub-pixel, the third numerical values include numerical values of the two primary-color sub-pixels and the brightness-enhancing sub-pixel.

7. The image processing method as claimed in claim 1, wherein the numerical values are grayscale values.

8. The image processing method as claimed in claim 1, wherein the primary-color sub-pixels comprises red, green, and blue sub-pixels, and the color of the brightness-enhancing sub-pixel is a mix of at least two of red, green, and blue primary colors.

9. The image processing method as claimed in claim 1, wherein the primary-color sub-pixels comprises cyan, magenta, and yellow sub-pixels, and the color of the brightness-enhancing sub-pixel is a mix of at least two of red, green, and blue primary colors.

10. A image processing method for generating multiple rows of pixel data comprised of three primary-color sub-pixels and a brightness-enhancing sub-pixel, where each two adjacent sub-pixels in one row are distinct from each other and two identical sub-pixels that are respectively arranged in two immediately adjacent rows are staggered in relation to each other with two sub-pixel positions, and a combination selected three at a time from these sub-pixels constituting a target pixel for the image processing method, the method comprising the steps of:
converting a three-color pixel into a four-color pixel by extracting a white component from the three-color pixel, where the sub-pixels of the four-color pixel identical with those of the target pixel are represented by first numerical values, and the sub-pixel of the four-color pixel different to that of the target pixel is represented by a second numerical value;
providing the target pixel with first numerical values and with third numerical values discarded by neighboring pixels of the target pixel; and
correlating the first numerical values with the third numerical values to determine the actual output numerical values of the target pixel.

11. The image processing method as claimed in claim 10, wherein the second numerical value is provided for each of the neighboring sub-pixels of the target pixel.

12. The image processing method as claimed in claim 10, wherein the sub-pixel not selected in the combination of the target pixel appears in an immediately adjacent area of each of the neighboring pixels of the target pixel.

13. The image processing method as claimed in claim 10, wherein each of the neighboring pixels is a combination selected three at a time from the three primary-color sub-pixels and the brightness-enhancing sub-pixel, and each of the third numerical values includes the numerical value of the sub-pixel not selected in the combination of each of the neighboring pixels.

14. The image processing method as claimed in claim 10, wherein the numerical values are grayscale values.

15. The image processing method as claimed in claim 10, wherein the primary-color sub-pixels comprises red, green, and blue sub-pixels, and the color of the brightness-enhancing sub-pixel is a mix of at least two of red, green, and blue primary colors.

16. The image processing method as claimed in claim 10, wherein the primary-color sub-pixels comprises cyan, magenta, and yellow sub-pixels, and the color of the brightness-enhancing sub-pixel is a mix of at least two of red, green, and blue primary colors.

17. A pixel arrangement used for a four-color liquid crystal display, comprising:
multiple rows of sub-pixels each comprised of a sequence of three primary-color sub-pixels and a brightness-enhancing sub-pixel, wherein each two adjacent sub-pixels in one row are distinct from each other, and two identical sub-pixels that are respectively arranged in two immediately adjacent rows are staggered in relation to each other with two sub-pixel positions.

18. The pixel arrangement as claimed in claim 17, wherein all sub-pixels have identical areas.

19. The pixel arrangement as claimed in claim 17, wherein the primary-color sub-pixels comprises red, green, and blue sub-pixels, and the color of the brightness-enhancing sub-pixel is a mix of at least two of red, green, and blue primary colors.

20. The image processing method as claimed in claim 17, wherein the primary-color sub-pixels comprises cyan, magenta, and yellow sub-pixels, and the color of the brightness-enhancing sub-pixel is a mix of at least two of red, green, and blue primary colors.
